(19) United States
(12) Patent Application Publication
(10) Pub. No.: US 2025/0088989 A1
(43) Pub. Date: Mar. 13, 2025

(54) SYSTEMS AND METHODS FOR INDICATING TIMING DIFFERENCE BETWEEN DIFFERENT CELLS

(71) Applicant: ZTE CORPORATION, Shenzhen, Guangdong (CN)

(72) Inventors: Shuaihua KOU, Shenzhen (CN); Jing SHI, Shenzhen (CN); Xianghui HAN, Shenzhen (CN); Xingguang WEI, Shenzhen (CN)

(21) Appl. No.: 18/723,951

(22) PCT Filed: Feb. 18, 2022
(86) PCT No.: PCT/CN2022/076778

§ 371 Date: Jun. 25, 2024

(51) Int. Cl. H04W 56/00; H04W 36/08

(52) U.S. Cl. CPC H04W 56/0045; H04W 36/08

(57) ABSTRACT

A system and method for indicating timing difference between different cells. In one aspect, a wireless method may include measuring, by a wireless communication device, a current timing difference between a first time unit used in a first cell and a second time unit used in a second cell. In some embodiments, the method may include sending, by the wireless communication device to a wireless communication node, a message indicating the current timing difference.

### CROSS-REFERENCE TO RELATED APPLICATION(S)

This application is a national phase entry under 35 USC 371 of International Patent Application No. PCT/CN2022/076778 filed on Feb. 18, 2022, the entire content of the International Patent Application is incorporated herein by reference.

### TECHNICAL FIELD

The disclosure relates generally to wireless communications and, more particularly, to systems and methods for indicating timing difference between different cells.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. In one embodiment, a wireless communication device (e.g., user equipment) may measure a current timing difference between a first time unit used in a first cell and a second time unit used in a second cell. In some embodiments, the wireless communication device may send a message indicating the current timing difference, or a composition of a time interval, or an information of a switching period to a wireless communication node (e.g., base station). In certain embodiments, each of the first time unit and the second time unit may include one of: a symbol, a sub-slot, a slot, a sub-frame, or a frame.

In another aspect, the message may include in at least one of: a Radio Resource Control (RRC) signaling, a Medium Access Control (MAC) Control Element (CE), or a Uplink Control Information (UCI). In some embodiments, the current timing difference can be a difference between a first transmission timing corresponding to the first time unit and a second transmission timing corresponding to the second time unit.

In another aspect, the second time unit, along a time domain, can be closest to the first time unit than any other time unit used in the second cell. In some embodiments, the first time unit and second time unit may have an identical index. In some embodiments, the wireless communication device may periodically send the message to the wireless communication node.

In some embodiments, the wireless communication device may determine that a difference between the current timing difference and a previous timing difference can be equal to or greater than a threshold so as to send the message. In certain embodiments, the previous timing difference can be indicated by a last message reported by the wireless communication device to the wireless communication node.

In some embodiments, the wireless communication device may determine to switch uplink transmission from the first cell to the second cell. In some embodiments, the wireless communication device may identify that a switching period can be located in the first cell.

In some embodiments, the wireless communication device may determine to switch uplink transmission from a first cell group including the first cell to a second cell group including the second cell. In some embodiments, the wireless communication device may identify that a switching period can be located in the first cell group. In some embodiments, the wireless communication device may determine that a current composition/configuration of a current time interval, during which downlink reception and/or the uplink transmission is interrupted based on the switching period, may have changed from a previous composition/configuration of a previous time interval so as to send the message.

In certain embodiments, the current time interval and the previous time interval can be determined based on the switching period that has a same location within respective time units. In some embodiments, the previous time interval can be determined based on a previous timing difference.

In some embodiments, each of the current time interval and the previous time interval can be constituted of a plurality of time units, a starting one of which partially or fully overlaps with the switching period in a time domain. In some embodiments, the message may further include the information of the switching period that includes the first time unit or a last time unit.

At least one aspect is directed to a system, method, apparatus, or a computer-readable medium. In some embodiments, a wireless communication node may receive a message indicating a current timing difference, or a composition of a time interval, or a information of a switching period from a wireless communication device. In some embodiments, the current timing difference can be measured by the wireless communication device between a first time unit used in a first cell and a second time unit used in a second cell.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the readers understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIG. 3 illustrates an example of timing difference between cells, in accordance with some embodiments of the present disclosure.

FIG. 4 illustrates an example of the composition of a time interval, in accordance with some embodiments of the present disclosure.

FIG. 5 illustrates an example of the changing of timing difference based on the previous example, in accordance with some embodiments of the present disclosure.

FIG. 6 illustrates an example of the changing of the composition of the first time interval based on previous example, in accordance with some embodiments of the present disclosure.

FIG. 7 illustrates a flow diagram of an example method for indicating timing difference between different cells, in accordance with some embodiments of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

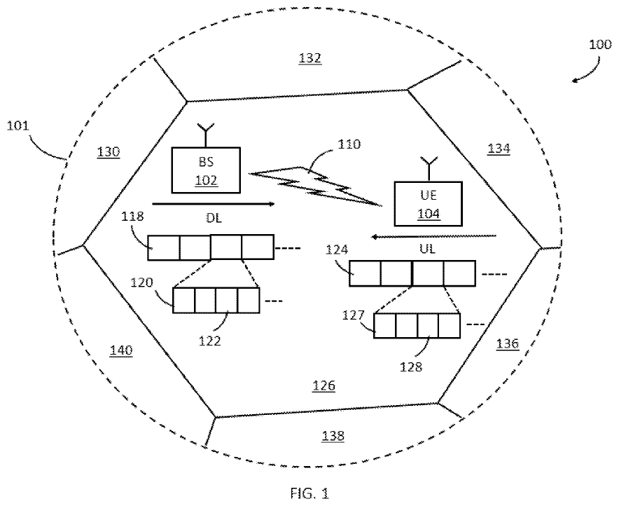

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100”. Such an example network 100 includes a base station 102 (hereinafter “BS 102”) and a user equipment device 104 (hereinafter “UE 104”) that can communicate with each other via a communication link 110 (e.g., a wireless communication channel), and a duster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

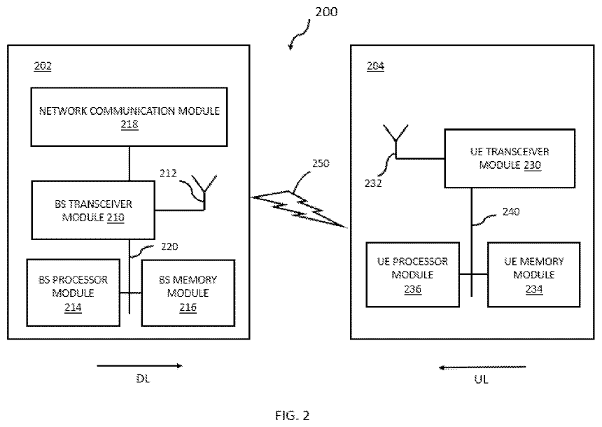

FIG. 2 illustrates a block diagram of an example wireless communication system 200 for transmitting and receiving wireless communication signals, e.g., OFDM (orthogonal frequency division multiplexing)/OFDMA (orthogonal frequency division multiplexing access) signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To dearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 230 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 214 and 236, respectively, such that the processors modules 214 and 236 can read information from, and write information to, memory modules 216 and 234, respectively. The memory modules 216 and 234 may also be integrated into their respective processor modules 214 and 236. In some embodiments, the memory modules 216 and 234 may each include a cache memory for storing temporary variables or other intermediate information during execution of instructions to be executed by processor modules 214 and 236, respectively. Memory modules 216 and 234 may also each include non-volatile memory for storing instructions to be executed by the processor modules 214 and 236, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX (World Interoperability for Microwave Access) traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

### B. Indicating Timing Difference Between Different Cells

A wireless communication device (e.g., UE) may be equipped/provided with fixed number of transmission/communication ports. In some embodiments, a UE can be equipped/provided with two transmission/communication ports. The UE may transmit signal(s)/message(s)/information to two wireless communication nodes (e.g., serving cells). When (e.g., in response to) the UE is configured more than two serving cells or carriers, the uplink (UL) transmission can be switched between these cells or carriers with the purpose that the UE can transmit signal(s)/message(s)/information to all the serving cells or carriers at different times. The UL transmission switching may lead to a downlink (DL) reception interruption and/or an uplink (UL) transmission interruption. When (e.g., in response to) a UL transmission timing is not aligned between these serving cells or carriers, the network may not know the UL transmission interruption time and/or the DL reception interruption time. In certain embodiments, some methods/approaches are provided in such a way that the network can know such information/message(s) and perform more efficient scheduling of transmissions/communications.

### Embodiment 1

In some embodiments, a UE can be configured with a plurality of serving cells. A serving cell may include one or more uplink carriers. The UE can be configured with a plurality of uplink carriers. In addition, the UE can be configured with a plurality of serving cell groups/sets, or uplink carrier groups/sets. Each serving cell group may comprise one or more serving cells of the plurality of serving cells. Each uplink carrier group may comprise one or more uplink carriers of the plurality of uplink carriers.

The network may configure uplink transmission switching from one serving cell to another serving cell among the plurality of serving cells, or from one uplink carrier to another uplink carrier among the plurality of uplink carriers. For the uplink transmission switching between a first serving cell and a second serving cell, the network may configure that a switching period can be located in one serving cell (e.g., in the first serving cell or in the second serving cell). In addition, the network may configure that which one may be carrier 1 and/or which one may be carrier 2. If a serving cell is configured to be carrier 1, all the uplink carriers of this serving cell can be carrier 1. If a serving cell is configured to be carrier 2, all the uplink carriers of this serving cell can be carrier 2. A length of the switching period may be reported/determined/obtained/configured via/by the UE or configured by the network. In some embodiments, the length of the switching period may be sum of a value reported by the UE and a first value. The first value may be configured by a network and/or specified by a protocol. In certain embodiments, the first value can be equal to the timing difference between one (serving) cell and another (serving) cell.

For example, for the uplink transmission switching between a first uplink carrier and a second uplink carrier, the network may configure that switching period can be located in one uplink carrier (e.g., in the first uplink carrier or the second uplink carrier). The network may configure that which one can be carrier 1 and/or which one can be carrier 2.

The network may configure an uplink transmission switching from one serving cell group to another serving cell group among a plurality of serving cell groups, or from one uplink carrier group to another uplink carrier group among a plurality of the uplink carrier groups. For the uplink transmission switching between a first group and a second group, the network may configure that the switching period can be located in one group (e.g., in the first group or in the second group). In addition, the network can configure that which one can be carrier 1 and/or which one can be carrier 2. The group can be a serving cell group or an uplink carrier group. If the serving cell group or the uplink carrier group is configured to be carrier 1, all the uplink carriers of the serving cell group or all the uplink carriers of the uplink carrier group can be carrier 1. If the serving cell group or the uplink carrier group is configured to be carrier 2, all the uplink carriers of the serving cell group or all the uplink carriers of the uplink carrier group can be carrier 2.

During the switching period, the UE may not be allowed/enabled/supported to transmit any signal(s)/message(s)/information to the serving cells. If a configured transmission/communication overlaps with the switching period, the transmission/communication can be dropped. For a nominal physical uplink shared channel (PUSCH) repetition that may overlap with the switching period, the nominal PUSCH repetition can be segmented to actual PUSCH, where orthogonal frequency division multiplexing (OFDM) symbols overlapping with the switching period can be considered as invalid symbols. The dropped transmission/communication or the segmented PUSCH repetition can be transmitted on the carrier in which the switching period can be located.

In certain embodiments, a UE may be configured with 4 serving cells, denoted by cell 0, cell 1, cell 2 and cell 3, respectively. Each serving cell only may comprise one uplink carrier. The network may configure that the switching period can be located in the cell 0 for the uplink transmission switching between the cell 0 and cell 1. The network may configure that cell 0 can be carrier 1 and/or cell 1 can be carrier 2. The other configurations are shown in Table 1.

TABLE 1

| | Switching | | |
|---|---|---|---|
| | period | Carrier | Carrier |
| Case | carrier | 1 | 2 |
| Uplink transmission between | Cell 0 | Cell 0 | Cell 1 |
| cell 0 and cell 1 | | | |
| Uplink transmission between | Cell 2 | Cell 0 | Cell 2 |
| cell 0 and cell 2 | | | |
| Uplink transmission between | Cell 0 | Cell 0 | Cell 3 |
| cell 0 and cell 3 | | | |
| Uplink transmission between | Cell 2 | Cell 2 | Cell 1 |
| cell 1 and cell 2 | | | |
| Uplink transmission between | Cell 1 | Cell 3 | Cell 1 |
| cell 1 and cell 3 | | | |
| Uplink transmission between | Cell 3 | Cell 2 | Cell 3 |
| cell 2 and cell 3 | | | |

NOTE:
Switching period carrier is the carrier in which the Switching period is located.

The network may further configure/incorporate that group 0 may comprise cell 0 and/or cell 1. The group 1 may comprise cell 2 and/or cell 3. The group 2 may comprise cell 0 and/or cell 3. The group 3 may comprise cell 1. For the uplink transmission switching between group 0 and group 1, the network may configure that the switching period can be located in group 0 (e.g., in the cell 0 and/or cell 1). The network may configure that the group 0 can be carrier 1 and/or group 1 can be carrier 2. In some embodiments, cell 0 and/or cell 1 can be carrier 1 and cell 2 and/or cell 3 can be carrier 2 for the uplink transmission switching between group 0 and group 1. The other configurations for the uplink transmission switching are shown in Table 2.

TABLE 2

| | Switching | | |
|---|---|---|---|
| | period | Carrier | Carrier |
| Case | carrier | 1 | 2 |
| Uplink transmission between | Group 0 | Group 0 | Group 1 |
| group 0 and group 1 | | | |
| Uplink transmission between | Group 2 | Group 0 | Group 2 |
| group 0 and group 2 | | | |
| Uplink transmission between | Group 0 | Group 0 | Group 3 |
| group 0 and group 3 | | | |
| Uplink transmission between | Group 2 | Group 2 | Group 1 |
| group 1 and group 2 | | | |
| Uplink transmission between | Group 1 | Group 3 | Group 1 |
| group 1 and group 3 | | | |
| Uplink transmission between | Group 3 | Group 2 | Group 3 |
| group 2 and group 3 | | | |

NOTE:
Switching period carrier is the carrier in which the Switching period is located.

### Embodiment 2

In some embodiments, a UE may measure/calculate a timing difference between two (serving) cells. The timing difference can be a UL transmission timing difference between two cells. In one aspect, the timing difference can be the UL transmission timing difference between a first time unit boundary of a first (serving) cell and a second time unit boundary of a second (serving) cell. The timing difference can be a period of time between a timing when (e.g., in response to) the UE transmits the first time unit boundary of the first (serving) cell and another timing when (e.g., in response to) the UE transmits the second time unit boundary of the second (serving) cell. The time unit can be one of orthogonal frequency division multiplexing (OFDM) symbol, sub-slot, slot, sub-frame, or frame. The time unit boundary can be the starting boundary of the time unit or the ending boundary of the time unit. In some embodiments, the UE may send a signal/message/information indicating the timing difference, or a composition of a time interval, or a information of a switching period to a wireless communication node (e.g., base station).

In some embodiments, the second time unit can be a time unit of the second (serving) cell that may be the most close to the first time unit. The timing difference can be the UL transmission timing difference between a time unit of the first (serving) cell and the closest time unit of the second (serving) cell.

The second time unit may have the same time unit index (e.g., symbol, sub-slot, slot, sub-frame, and frame) with the first time unit. If the time unit is frame, the second frame and the first frame may have the same frame number. If the time unit is slot, the second slot may have the same slot number and/or the same frame number with the first slot. The timing difference can be the UL transmission timing difference between a time unit of the first (serving) cell and the closet time unit of the second (serving) cell with the same time unit index.

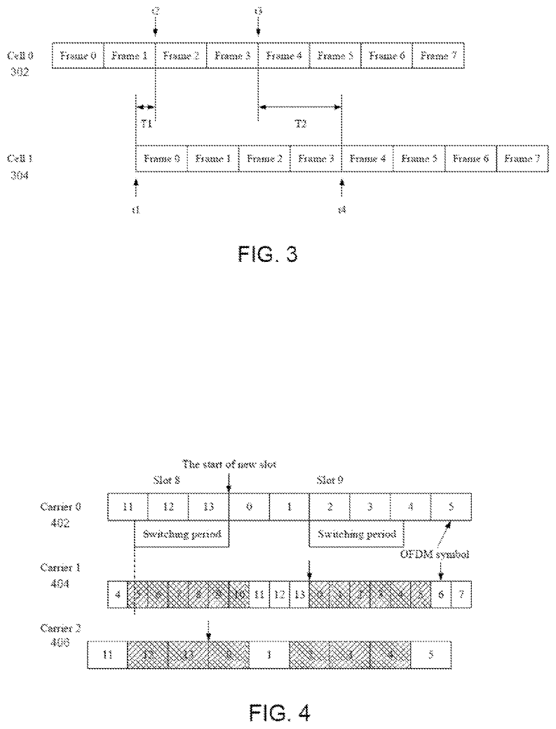

Referring now to FIG. 3, for a UE, there can be 8 frames in (serving) cell 0, 302, and (serving) cell 1, 304, each of which includes 8 frames that are denoted by frame 0˜7, respectively. The UE may measure/calculate the timing difference between a frame in (serving) cell 0, 302, and the closest frame in (serving) cell 1, 304. For frame 2 in (serving) cell 0, 302, the closest frame in (serving) cell 1, 304, can be frame 0. The timing difference can be the difference between the transmission time of the starting boundary of frame 2 in (serving) cell 0, 302, and the transmission time of the starting boundary of frame 0 in (serving) cell 1, 304. The UE may transmit the starting boundary of the frame 0 in (serving) cell 1, 304 at t1. The UE may transmit the starting boundary of the frame 2 in (serving) cell 0, 302, at t2. The timing difference (T1) can be t1−t2 or t2−t1.

The UE may measure/calculate the timing difference between a frame in (serving) cell 0, 302, and the closet frame in (serving) cell 1, 304, with the same frame number. The timing difference can be the difference between the transmission time of the starting boundary of the frame 4 in (serving) cell 0, 302, and the transmission time of starting boundary of the frame 4 in (serving) cell 1, 304. The UE may transmit the starting boundary of the frame 4 in (serving) cell 0, 302, at t3. The UE may transmit the starting boundary of the frame 4 in (serving) cell 1, 304, at t4. The timing difference (T2) can be t4−t3 or t3−t4. In certain embodiments, the UE may report/indicate/send the timing difference via a message/signal to the wireless communication node. The message/signal can be reported/indicated/sent by Radio Resource Control (RRC) signaling, Medium Access Control (MAC) Control Element (CE), or Uplink Control Information (UCI).

For a UL transmission switching, a DL reception interruption within a first time interval for a carrier may be caused by a switching period. The first time interval may comprise a plurality of OFDM downlink symbols. For example, the first time interval may comprise Y downlink OFDM symbols, where Y can be an integer larger than 0. The first time interval may start from a first symbol that fully or partly can overlap with the switching period for the UL transmission switching. The value of Y can be indicated by a network and/or specified by a protocol. The UE may not attempt to perform/provide a DL reception on these symbols (of the first time interval) in the carrier.

The UE may report/indicate/send the composition/configuration of the first time interval to the wireless communication node. For example, the UE may report a plurality of OFDM symbols comprised/included in the first time interval to the wireless communication node. The plurality of OFDM symbols of the first time interval can be determined, by the UE, by using a switching period that starts from the boundary of a certain time unit and/or by using a switching period that ends by the boundary of a certain time unit. The UE may report, to the wireless communication node, the plurality of OFDM symbols of the first time interval corresponding to one or more switching periods. The information of the switching period (e.g., the index of the starting time unit and/or the ending time unit of the switching period) may be reported together with the composition/configuration of the first time interval to the wireless communication node. If the switching period used for determining the plurality of OFDM symbols of the first time interval starts from a boundary of a time unit, the index of the first time unit within the switching period can be reported/indicated/sent to the wireless communication node. If the switching period used for determining the plurality of OFDM symbols of the first time interval ends by a boundary of a time unit, the index of the last time unit within the switching period can be reported/indicated/sent to the wireless communication node.

Referring now to FIG. 4, for a UE, there can be three carriers, which can be denoted by carrier 0, 402, carrier 1, 404, and carrier 2, 406, respectively. For carrier 0, 402, an uplink transmission timing is illustrated. For carrier 1, 404, and carrier 2, 406, a downlink reception timing is illustrated. The subcarrier spacing (SCS) of carrier 0, 402, and carrier 2, 406, can be 15 kHz. The SCS of carrier 1, 404, can be 30 kHz. The length of OFDM symbol of 15 kHz is two times of the OFDM symbol of 30 kHz. A slot may comprise 14 OFDM symbols, which can be denoted by symbol 0˜13, respectively. A first time interval may comprise a plurality of OFDM downlink symbols. In carrier 1, 404, the first time interval may comprise 6 symbols. In carrier 2, 406, the first time interval may comprise 3 symbols.

The switching period can be located in the carrier 0, 402. The switching period can start at any time. In one example, two switching periods are illustrated. The first switching period may end by the ending boundary of OFDM symbol 13 (or the ending boundary of the slot 8, or the starting boundary of the slot 9, or the starting boundary of OFDM symbol 0). In carrier 1, 404, the first symbol that fully or partly overlaps with the first switching period is symbol 5. The first time interval may comprise symbol 5, 6, 7, 8, 9, and 10 in carrier 1, 404. In carrier 2, 406, the first symbol that fully or partly overlaps with the first switching period is symbol 12. The first time interval may comprise symbol 12, 13 and 0 in carrier 2, 406.

The second switching period may start from the starting boundary of symbol 2 (or ending boundary of symbol 1) in carrier 0, 402. In carrier 1, 404, the first symbol that fully or partly overlaps with the second switching period is symbol 0. The first time interval may comprise symbol 0, 1, 2, 3, 4, and 5. In carrier 2, 406, the first symbol that fully or partly overlaps with the second switching period is symbol 2. The first time interval may comprise symbol 2, 3, and 4.

The UE may report/indicate/send, to a wireless communication node, that the first time interval can comprise symbol 5, 6, 7, 8, 9, and 10 in carrier 1, 404, and/or symbol 12, 13, and 0 in carrier 2, 406, for the switching period located in carrier 0, 402, that ends by an ending boundary of symbol 13, and/or the first time interval may comprise symbol 0, 1, 2, 3, 4, and 5 in carrier 1, 404, and/or symbol 2, 3, and 4 in carrier 2, 406, for the switching period located in carrier 0, 402, that starts from the starting boundary of symbol 2.

For an uplink transmission switching, a UE may report/indicate/send a plurality of serving cells with a DL reception interruption caused by a switching period. The UE may report a composition/configuration of a first time interval in the plurality of serving cells. In certain embodiments, if more than one serving cells belong to a timing advance group (TAG), the UE may report the composition/configuration of the first time interval corresponding to only one of the more than one serving cells. In some embodiments, the UE may report the composition/configuration of the first time interval in the carrier affected/influenced by the uplink switching between each one carrier and another carrier among a plurality of carriers.

The UE may report/indicate/send at least one of: the timing difference or the composition/configuration of the first time interval message/information, or the message/information of the switching period used for determining the composition/configuration of the first time interval to the wireless communication node. In various embodiments, information (e.g., length, starting boundary, ending boundary, index of corresponding starting time unit, and index of corresponding ending time unit) of the switching period can be reported together with the composition/configuration of the first time interval. The UE may periodically send/report/indicate at least one of: the timing difference, the composition/configuration, or the message/information of the switching period to the wireless communication node. In some embodiments, the UE may report/send/indicate at least one of: the timing difference or the composition/configuration of the first time interval or the message/information of the switching period used for determining the composition/configuration of the first time interval to the wireless communication node when (e.g., in response to) the change of the measured/calculated timing difference is equal to or larger than a threshold Z (Z>0) compared to the last timing difference that the UE may report to the wireless communication node. The value of the threshold Z can be configured by a network and/or specified by a protocol. If a timing difference is reported/updated by the UE successfully, the reported/updated timing difference can be used/applied as a reference for a subsequent timing difference change determination.

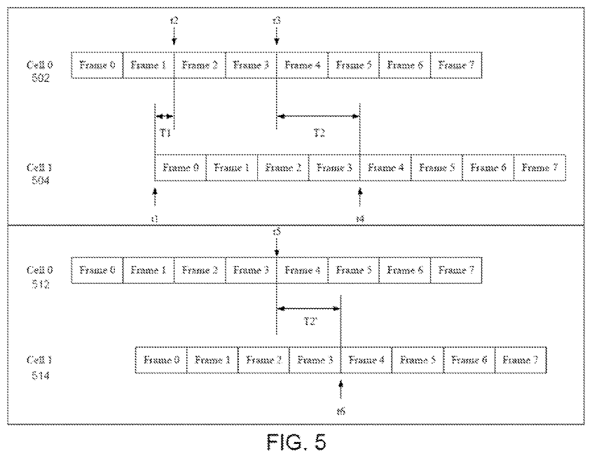

Referring now to FIG. 5, at one moment, a UE may transmit a starting boundary of frame 4 in (serving) cell 0, 502, at t3. The UE may transmit the starting boundary of frame 4 in (serving) cell 1, 504, at t4. The timing difference (T2) can be t3−t4 or t4−t3. The timing difference T2 may be sent to the wireless communication node. At another moment, the timing difference (T2′) can be t5−t6 or t6−t5, since the UE may transmit the starting boundary of frame 4 in (serving) cell 0, 512, at t5, and the UE may transmit the starting boundary of frame 4 in (serving) cell 1, 514, at t6. If the difference between T2 and T2′ is equal to or larger than Z, the UE may report/indicate/send/update at least one of: the new timing difference (e.g., T2′) or the composition/configuration of the first time interval, or the message/information of the switching period used for determining the composition/configuration of the first time interval to the wireless communication node. After reporting/updating the timing difference, the reported/updated timing difference (e.g., T2′) can be used as a reference for determining/estimating/calculating the timing difference change between (serving) cell 0 and (serving) cell 1 subsequently.

In some embodiments, the UE may report at least one of the timing difference or the composition/configuration of the first time interval, or the message/information of the switching period used for determining the composition/configuration of the first time interval to the wireless communication node when the composition/configuration of the first time interval changes. The composition/configuration of the first time interval may change due to a UL transmission timing difference. If the composition/configuration of the first time interval is reported/indicated/sent by the UE successfully, the reported composition/configuration of the first time interval can be used/applied as a reference for the subsequent composition/configuration of the first time interval change determination subsequently. When determining the change of the composition/configuration of the first time interval, the same location of the switching period in the time unit can be used.

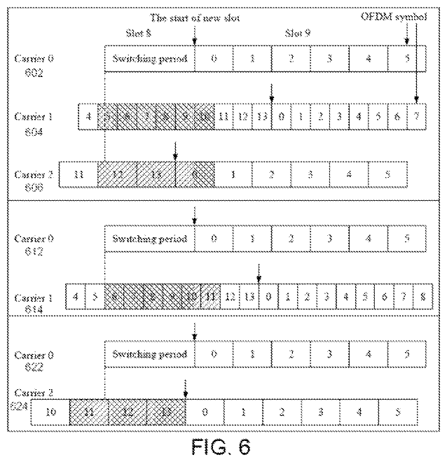

Referring now to FIG. 6, for a UE, a switching period located in carrier 0, 602, may end by the ending boundary of slot 8. For the switching period, at the first moment, the first time interval may comprise symbol 5, 6, 7, 8, 9, and 10 in carrier 1, 604, and/or symbol 12, 13 and 0 in carrier 2, 606.

At the second moment, in carrier 1, 614, the first symbol that fully or partly overlaps with the starting boundary of switching period in carrier 0, 612, is symbol 6. The first time interval may comprise symbol 6, 7, 8, 9, 10 and 11 in carrier 1, 614. The composition/configuration of the first time interval in carrier 1 may change from symbol 5˜10 to symbol 6˜11. The UE can report/indicate/send at least one of: the timing difference or composition/configuration of the first time interval in carrier 1, 614 or the ending time unit of the switching period in carrier 0, 612. After successful reporting, the reported composition/configuration of the first time interval (e.g., symbol 6˜11) can be used for determining/estimating/calculating the composition/configuration of the first time interval change in carrier 1 subsequently.

At the third moment, in carrier 2, 624, the first symbol that fully or partly overlaps with the starting boundary of switching period in carrier 0, 622, is symbol 11. The first time interval comprises symbol 11, 12, and 13 in carrier 2, 624. The composition/configuration of the first time interval in carrier 2 may change from symbol 12, 13, and 0 to symbol 11, 12, and 13. The UE can report/indicate/send at least one of: the timing difference or composition/configuration of the first time interval in carrier 2, 624 or the ending time unit of the switching period in carrier 0, 622. After successful reporting, the reported composition/configuration of the first time interval (e.g., symbol 11, 12, 13) can be used for determining/estimating/calculating the composition/configuration of the first time interval change in carrier 2 subsequently.

A composition/configuration of a first time interval can be affected/influenced by a location of a switching period and/or a timing difference. The switching period can be anywhere. For example, there are two switching periods with different locations in a slot in FIG. 4. The composition/configuration of the first time intervals corresponding to the two switching period can be different. In certain embodiments, the location of the switching period may remain unchanged in such a way that the only factor that may lead to the change of composition/configuration of the first time interval is timing difference. The switching period location is not changed in FIG. 6.

### Embodiment 3

A UE can be configured by a network with a plurality of serving cells. At least a first serving cell of the plurality of serving cells may belong to a first timing advance group (TAG). At least a second serving cell of the plurality of serving cells may belong to a second TAG. When (e.g., in response to) a control information/configuration carried in a downlink transmission transmitted in the first serving cell schedules a uplink transmission in the second serving cell, a uplink transmission timing difference between the first serving cell and the second serving cell (or between the first TAG and the second TAG) can be taken into account for a second time interval between the uplink transmission and a downlink transmission.

The control information/configuration can be a downlink control information (DCI), a MAC CE, or a RRC signaling. The uplink transmission can be a physical uplink control channel (PUCCH) or a physical uplink shared channel (PUSCH). The downlink transmission can be a physical downlink control channel (PDCCH) carrying the control information or a physical downlink shared channel (PDSCH) scheduled by the control information.

A PDSCH scheduled by a downlink control information (DCI) and corresponding to a PUCCH transmitted on a second serving cell, may be transmitted on a first serving cell. The PUCCH may carry a Hybrid Automatic Repeat Request Acknowledge (HARQ-ACK) for the PDSCH. If the time interval between the PDSCH and the PUCCH should be larger than X1 when the first (serving) cell and the second (serving) cell belong to the same TAG, the time interval between the PDSCH and the PUCCH should be larger than X1+D when the first (serving) cell and the second (serving) cell belong to different TAGs, where D can be the uplink transmission timing difference between the first (serving) cell and the second (serving) cell. The value of X1 can be configured by the network or specified by a protocol.

For example, if a first uplink symbol of a PUCCH which carries a HARQ-ACK information, as defined by the assigned HARQ-ACK timing K₁ and the PUCCH resource to be used, including the effect of the timing advance, starts no earlier than at symbol L₁, where L₁ can be defined as a next uplink symbol with its Cyclic Prefix (CP) starting after T_{proc,1}=(N₁+d_{1,1}+d₂)(2048+144)·κ2^{-μ}·T_{c}+Tₑₓₜ+T_{delta} after the end of the last symbol of the PDSCH carrying the transport block (TB) being acknowledged, the UE can provide a valid HARQ-ACK message, where T_{delta} can be the uplink transmission timing difference between the (serving) cell for PDSCH transmission and the (serving) cell for the PUCCH transmission. The value of T_{proc,1}, N₁, d_{1,1}, d₂, T_{c}, and Tₑₓₜ can be configured by the network or specified by a protocol.

A DCI transmitted on a first (serving) cell may schedule a PUSCH transmitted on the second (serving) cell. If the time interval between the PDCCH carrying the DCI and the PUSCH should be larger than X2 when the first (serving) cell and the second (serving) cell belong to the same TAG, the time interval between the PDCCH carrying the DCI and the PUSCH should be larger than X2+D when the first (serving) cell and the second (serving) cell belong to different TAGs, where D can be the uplink transmission timing difference between the first (serving) cell and the second (serving) cell. The value of X2 can be configured by the network or specified by a protocol.

For example, if a first uplink symbol in a PUSCH allocation for a transport block, including a demodulation reference signal (DM-RS), as defined by a slot offset K₂ and a start S and a length L of the PUSCH allocation indicated by Time domain resource assignment of a scheduling DCI, including a effect of a timing advance, is no earlier than at symbol L₂, where L₂ can be defined as the next uplink symbol with its CP starting after T_{pro,2}=max((N₂+d_{2,1}+d₂)(2048+144)·κ2^{-μ}+Tₑₓₜ+T_{switch}+T_{delta}, d_{2,2}) after the end of a reception of the last symbol of the PDCCH carrying the DCI scheduling the PUSCH, the UE may transmit the transport block, where T_{delta} can be the uplink transmission timing difference between the (serving) cell for PDCCH transmission and the (serving) cell for the PUSCH transmission. The value of T_{pro,2}, N₂, d_{2,1}, d₂, Tₑₓₜ, T_{switch}, and d_{2,2} can be configured by the network or specified by a protocol.

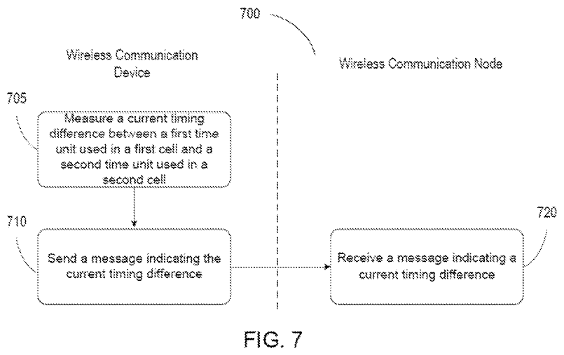

FIG. 7 illustrates a flowchart diagram illustrating a method 700 for indicating timing difference between different (serving) cells, in accordance with some embodiments of the present disclosure. Referring to FIGS. 1-6, the method 700 can be performed by a wireless communication device (e.g., a UE), in some embodiments. Additional, fewer, or different operations may be performed in the method 700 depending on the embodiment.

A wireless communication device may measure/calculate a current timing difference between a first time unit used in a first (serving) cell and a second time unit used in a second (serving) cell (705). The wireless communication device may send a message indicating the current timing difference to a wireless communication node (710). A wireless communication node may receive a message indicating a current timing difference (720).

In one embodiment, a wireless communication device (e.g., user equipment) may measure a current timing difference between a first time unit used in a first (serving) cell and a second time unit used in a second (serving) cell. In some embodiments, the wireless communication device may send a message indicating the current timing difference, or a composition of a time interval, or a information of a switching period to a wireless communication node. The message may include in at least one of: a Radio Resource Control (RRC) signaling, a Medium Access Control (MAC) Control Element (CE), or a Uplink Control Information (UCI). Each of the first time unit and the second time unit may include one of: a symbol, a sub-slot, a slot, a sub-frame, or a frame.

In some embodiments, the current timing difference can be a difference between a first transmission timing corresponding to the first time unit and a second transmission timing corresponding to the second time unit.

In some embodiments, the second time unit, along a time domain, can be closest to the first time unit than any other time unit used in the second (serving) cell. In some embodiments, the first time unit and second time unit may have an identical index. In certain embodiments, the wireless communication device may periodically send the message to the wireless communication node.

In some embodiments, the wireless communication device may determine that a difference between the current timing difference and a previous timing difference can be equal to or greater than a threshold so as to send the message. In certain embodiments, the previous timing difference can be indicated by a last message reported by the wireless communication device to the wireless communication node.

In some embodiments, the wireless communication device may determine to switch uplink transmission from the first (serving) cell to the second (serving) cell. In some embodiments, the wireless communication device may identify that a switching period can be located in the first (serving) cell.

In some embodiments, the wireless communication device may determine to switch uplink transmission from a first (serving) cell group including the first (serving) cell to a second (serving) cell group including the second (serving) cell. In some embodiments, the wireless communication device may identify that a switching period can be located in the first (serving) cell group. In some embodiments, the wireless communication device may determine that a current composition/configuration of a current time interval, during which downlink reception and/or the uplink transmission is interrupted based on the switching period, may have changed from a previous composition/configuration of a previous time interval so as to send the message.

In certain embodiments, the current time interval and the previous time interval can be determined based on the switching period that has a same location within respective time units. In some embodiments, the previous time interval can be determined based on a previous timing difference.

In some embodiments, each of the current time interval and the previous time interval can be constituted of a plurality of time units, a starting one of which partially or fully overlaps with the switching period in a time domain. In some embodiments, the message may further include the information of the switching period that includes the first time unit or a last time unit.

At least one aspect is directed to a system, method, apparatus, or a computer-readable medium. In some embodiments, a wireless communication node may receive a message indicating a current timing difference, or a composition of a time interval, or a information of a switching period from a wireless communication device. In some embodiments, the current timing difference can be measured by the wireless communication device between a first time unit used in a first (serving) cell and a second time unit used in a second (serving) cell.

While various embodiments of the present solution have been described above, it should be understood that they have been presented by way of example only, and not by way of limitation. Likewise, the various diagrams may depict an example architecture or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
measuring, by a wireless communication device, a current timing difference between a first time unit used in a first cell and a second time unit used in a second cell; and
sending, by the wireless communication device to a wireless communication node, a message indicating the current timing difference, or a composition of a time interval, or an information of a switching period.

2. The wireless communication method of claim 1, wherein each of the first time unit and the second time unit comprises one of: a symbol, a sub-slot, a slot, a sub-frame, or a frame.

3. The wireless communication method of claim 1, wherein the message is comprised in at least one of: a Radio Resource Control (RRC) signaling, a Medium Access Control (MAC) Control Element (CE), or an Uplink Control Information (UCI).

4. The wireless communication method of claim 1, wherein the current timing difference is a difference between a first transmission timing corresponding to the first time unit and a second transmission timing corresponding to the second time unit.

5. The wireless communication method of claim 1, wherein the second time unit, along a time domain, is closest to the first time unit than any other time unit used in the second cell; or
the first time unit and second time unit have an identical index.

6. (canceled)

7. The wireless communication method of claim 1, further comprising:
periodically sending, by the wireless communication device to the wireless communication node, the message.

8. The wireless communication method of claim 1, further comprising:
determining, by the wireless communication device, that a difference between the current timing difference and a previous timing difference is equal to or greater than a threshold so as to send the message.

9. The wireless communication method of claim 8, wherein the previous timing difference is indicated by a last message reported by the wireless communication device to the wireless communication node.

10. The wireless communication method of claim 1, further comprising:
determining, by the wireless communication device, to switch uplink transmission from the first cell to the second cell; and
identifying, by the wireless communication device, that the switching period is located in the first cell.

11. The wireless communication method of claim 1, further comprising:
determining, by the wireless communication device, to switch uplink transmission from a first cell group comprising the first cell to a second cell group comprising the second cell; and
identifying, by the wireless communication device, that the switching period is located in the first cell group.

12. The wireless communication method of claim 10, further comprising:
determining, by the wireless communication device, that a current composition of a current time interval, during which downlink reception and/or the uplink transmission is interrupted based on the switching period, has changed from a previous composition of a previous time interval so as to send the message.

13. The wireless communication method of claim 12, wherein the current time interval and the previous time interval are determined based on the switching period that has a same location within respective time units.

14. The wireless communication method of claim 12, wherein the previous time interval is determined based on a previous timing difference.

15. The wireless communication method of claim 12, wherein each of the current time interval and the previous time interval is constituted of a plurality of time units, a starting one of which partially or fully overlaps with the switching period in a time domain.

16. The wireless communication method of claim 10, wherein the message further comprises the information of the switching period that comprising the first time unit or a last time unit.

17. A wireless communication method, comprising:
receiving, by a wireless communication node from a wireless communication device, a message indicating a current timing difference, or a composition of a time interval, or a information of a switching period;
wherein the current timing difference is measured by the wireless communication device between a first time unit used in a first cell and a second time unit used in a second cell.

18. A wireless communications apparatus comprising a processor and a memory, wherein the processor is configured to read code from the memory and implement steps of:
measuring a current timing difference between a first time unit used in a first cell and a second time unit used in a second cell; and
sending, to a wireless communication node, a message indicating the current timing difference, or a composition of a timer interval, or an information of a switching period.

19. (canceled)

20. A wireless communications apparatus comprising a processor and a memory, wherein the processor is configured to read code from the memory and implement the method of claim 17.

21. The wireless communication method of claim 11, further comprising:
determining, by the wireless communication device, that a current composition of a current time interval, during which downlink reception and/or the uplink transmission is interrupted based on the switching period, has changed from a previous composition of a previous time interval so as to send the message.

22. The wireless communication method of claim 11, wherein the message further comprises the information of the switching period that comprises the first time unit or a last time unit.
